(19) United States
(12) Patent Application Publication
(10) Pub. No.: US 2012/0305668 A1
(43) Pub. Date: Dec. 6, 2012

(54) Spray Bottle and Methods of Making and Using the Same

(76) Inventor: Andy Davis, McDonough, GA (US)

(21) Appl. No.: 13/576,110

(22) PCT Filed: Mar. 11, 2010
(86) PCT No.: PCT/US10/27034

§ 371 Date: Jul. 30, 2012

Related U.S. Application Data
(60) Provisional application No. 61/299,435, filed on Jan. 29, 2010.

(51) Int. Cl. B05B 9/00

(52) U.S. Cl. 239/375

(57) ABSTRACT

Spray bottles are disclosed. Methods of making and using spray bottles are also disclosed.

This application is being filed as a PCT International Patent Application in the name of Andy Davis, a U.S. citizen, claiming priority to U.S. Provisional Patent Application Ser. No. 61/299,435 filed on 29 Jan. 2010, which is entitled “SPRAY BOTTLE AND METHODS OF MAKING AND USING THE SAME.”

### TECHNICAL FIELD

The present invention relates to spray bottles, methods of making spray bottles, and methods of using spray bottles.

### BACKGROUND

Efforts continue to develop spray bottles that (1) efficiently and effectively spray a fluid (e.g., a liquid), (2) are relatively easy to use, (3) provide an aesthetically pleasing look for spray manufacturers, and (4) are economical to use and make.

### SUMMARY

The present invention continues the effort to develop spray bottles by the discovery of spray bottles that (i) are efficiently and effectively spray a fluid (e.g., a liquid), (ii) are relatively easy to use, (iii) provide an aesthetically pleasing look for spray manufacturers, and (iv) are economical to use and make.

In one exemplary embodiment, the spray bottle of the present invention comprises a container comprising an upper end, a lower end, and at least one major side surface between the upper end and the lower end; a spray mechanism operatively adapted to spray a fluid from the container; a spray trigger operatively adapted to initiate fluid flow of a fluid from the container through the spray mechanism; and an aperture extending through the at least one major side surface of the container from a first side of the container to a second side of the container, the aperture being completely surrounded by portions of the at least one major side surface; wherein the spray trigger is positioned within said aperture.

In another exemplary embodiment, the spray bottle of the present invention comprises a container comprising an upper end, a lower end, and at least one major side surface between the upper end and the lower end; an upper piece and a lower piece, the upper and lower pieces being operatively adapted to connect to one another to form (i) the container and (ii) the at least one major side surface; a spray mechanism operatively adapted to spray a fluid from the container; a spray trigger operatively adapted to initiate fluid flow of a fluid from the container through the spray mechanism; and an aperture extending through the at least one major side surface of the container from a first side of the container to a second side of the container, the aperture being completely surrounded by portions of the at least one major side surface; wherein the spray trigger is positioned within the aperture, and the aperture extends through at least a portion of the upper piece.

In yet another exemplary embodiment, the spray bottle of the present invention comprises a container comprising an upper end, a lower end, and at least one major side surface between the upper end and the lower end; a spray mechanism comprising (i) a spray fluid reservoir, (ii) a plunger operatively adapted to extend into the spray fluid reservoir in response to a spray initiation force, (iii) a fluid expulsion member in fluid communication with the spray fluid reservoir, and (iv) a hollow straw in fluid communication with and extending below the spray fluid reservoir into a fluid storage compartment of the container; an aperture extending through the at least one major side surface of the container from a first side of the container to a second side of the container, the aperture being completely surrounded by portions of the at least one major side surface; and a spray trigger positioned within the aperture, the spray trigger being operatively adapted to initiate fluid flow of a fluid from the container through the spray mechanism; wherein the plunger moves toward (i) the fluid expulsion apparatus and (ii) a fluid exit of the container in response to a spray initiation force exerted on the plunger by an upper region of the spray trigger.

In yet another exemplary embodiment, the spray bottle of the present invention comprises a spray bottle comprising a container comprising an upper end, a lower end, and at least one major side surface between the upper end and the lower end; a spray mechanism comprising (i) a spray fluid reservoir, (ii) a plunger operatively adapted to extend into the spray fluid reservoir in response to a spray initiation force, (iii) a fluid expulsion member in fluid communication with the spray fluid reservoir, and (iv) a hollow straw in fluid communication with and extending below the spray fluid reservoir into a fluid storage compartment of the container; an aperture extending through the at least one major side surface of the container from a first side of the container to a second side of the container, the aperture being completely surrounded by portions of the at least one major side surface; and a spray trigger positioned within the aperture, the spray trigger being operatively adapted to initiate fluid flow of a fluid from the container through the spray mechanism; wherein the (i) hollow straw and (ii) a fluid exit of the container are both positioned in front of the spray trigger and the aperture.

In yet a further exemplary embodiment, the spray bottle of the present invention comprises a container comprising an upper end, a lower end, and at least one major side surface between the upper end and the lower end; a spray mechanism operatively adapted to spray a fluid from within the container through a fluid exit of the container; an aperture extending through the at least one major side surface of the container from a first side of the container to a second side of the container, the aperture being completely surrounded by portions of the at least one major side surface; and a spray trigger positioned within the aperture, the spray trigger being operatively adapted to initiate fluid flow of a fluid from the container through the spray mechanism; wherein the aperture has a cross-sectional shape selected from the group of shapes consisting of a circle, a square, a triangle, a rhombus, a star, a hexagon, a rectangle, a parallelogram, or any other multi-sided shape.

The present invention is further directed to methods of making the disclosed spray bottles and methods of using the disclosed spray bottles.

These and other features and advantages of the present invention will become apparent after a review of the following detailed description of the disclosed embodiments and the appended claims.

### BRIEF DESCRIPTION OF THE DRAWINGS

The present invention is further described with reference to the appended figures, wherein:

FIG. 1 depicts a ¾ angle view of an exemplary spray bottle of the present invention showing an exemplary spray bottle aperture therein with an exemplary trigger within the exemplary aperture;

FIG. 2 depicts a side elevation view of an exemplary top piece suitable for forming an upper portion of the exemplary spray bottle of FIG. 1;

FIG. 3 depicts a front view of an exemplary lower piece suitable for forming the exemplary spray bottle of FIG. 1;

FIG. 4 depicts a side elevation view of the exemplary lower piece of FIG. 3;

FIG. 5 depicts an underside view of the exemplary top piece of FIG. 2 with exemplary spray pump mechanism and trigger attached;

FIG. 6 depicts an underside view of the exemplary top piece of FIG. 2 with only an exemplary trigger attached;

FIG. 7 depicts a view of the exemplary lower piece of FIG. 3 as viewed from above (and down on) the exemplary lower piece;

FIG. 8 depicts a view of the exemplary lower piece of FIG. 3 as viewed from below (and up at) the exemplary lower piece;

FIG. 9 depicts a side view of another exemplary spray bottle of the present invention showing an exemplary spray bottle aperture therein with an exemplary trigger within the exemplary aperture;

FIG. 10 depicts a cut-away view of (i) an exemplary top piece with spray trigger attached and (ii) an exemplary lower section of the exemplary spray bottle of FIG. 9;

FIG. 11 depicts a side view of an exemplary spray pump mechanism, an exemplary hollow straw, and an exemplary trigger device attached to the exemplary spray pump mechanism with exemplary tension clips;

FIG. 12 depicts a view of the exemplary spray pump mechanism and the exemplary trigger device of FIG. 11 as viewed from above the exemplary spray pump mechanism;

FIG. 13 depicts a view of the exemplary spray bottle of FIG. 9 as viewed from above the exemplary spray bottle;

FIG. 14 depicts an elevation view of the back side of the exemplary spray bottle of FIG. 9;

FIG. 15 depicts an elevation view of the front side of the exemplary spray bottle of FIG. 9;

FIG. 16 depicts a cut-away view of an exemplary top piece and an exemplary lower section of the exemplary spray bottle of FIG. 9 showing an exemplary spray pump mechanism, an exemplary hollow straw and an exemplary trigger device attached with an exemplary metal or plastic pin;

FIG. 17 depicts a rear view of (i) the exemplary spray trigger attached to (ii) the exemplary spray pump mechanism shown in FIG. 16; and

FIG. 18 shows the front view of (i) the exemplary spray pump mechanism, (ii) the exemplary hollow straw, and (iii) the exemplary trigger device shown in FIG. 16.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

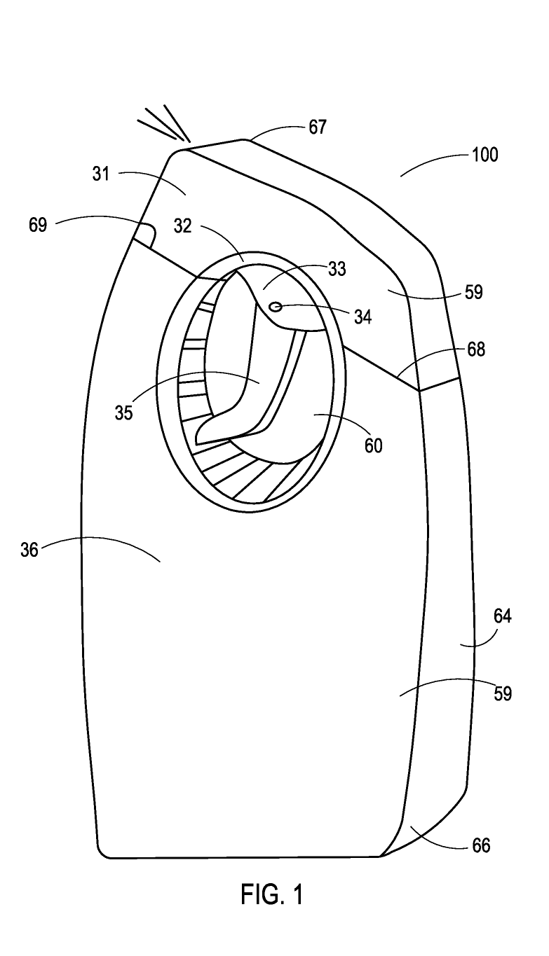

The present invention is directed to spray bottles as shown in FIGS. 1-18, and as described in the claims below. As used herein, the term “multi-sided shape” refers to a shape comprising three or more sides (e.g., a triangular shape having three sides, a square shape having four sides, etc.). The term “multi-sided shape” also refers to complex shapes that comprise one or more straight sides, one or more curved sides, one or more indentations sized so that a user's finger(s) may be positioned within the one or more indentations of the aperture shape, or any combination thereof.

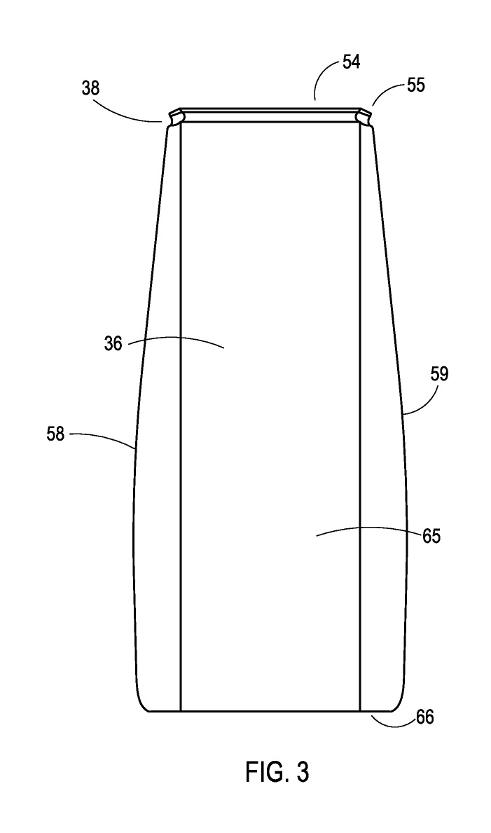

As shown, for example, in FIGS. 1 and 3, exemplary spray bottle 100 comprises an upper end 67, a lower end 66, and two major side surfaces 58 and 59 extending between upper end 67 and the lower end 66. Exemplary spray bottle 100 actually comprises two major side surfaces 58 and 59 (opposite one another and through which the aperture 60 extends), as well as two minor side surfaces 64 and 65 (opposite one another and extending between the two major side surfaces 58 and 59). In other configurations (not shown), a given spray bottle may have a single major side surface, such as when the spray bottle has a circular cross-sectional configuration. It should be understood that there are no limitations with regard to the shape of the spray bottle of the present invention other than having an aperture 60 extending through at least one major side surface (e.g., major side surfaces 58 and 59) of the spray bottle with a spray trigger 35 positioned within the aperture 60.

As shown in FIGS. 1 and 3, exemplary spray bottle 100 comprises two major side surfaces 58 and 59 with a first major side surface 58 along the first side of the container, and a second major side surface 59 along the second side of the container. As shown in FIG. 1, major side surface 59 extends from upper end 67 to lower end 66, and encompasses aperture 60. Aperture 60 extends through exemplary spray bottle 100 and provides therein a spray trigger 35, support structure 33 for spray trigger 35 and positioned in an upper portion of aperture 60 along aperture edge 32, and metal or plastic pin 34 to attach spray trigger 35 to support structure 33 and provide a pivot point for spray trigger 35.

As further shown in FIG. 1 and subsequent figures, exemplary spray bottle 100 comprises an upper piece 31 and a lower piece 36, with upper and lower pieces 31 and 36 being operatively adapted to connect to one another at connection locations 68 and 69 to form exemplary spray bottle 100 and the at least one major side surface (e.g., two major side surfaces 58 and 59).

In some exemplary embodiments, such as with exemplary spray bottle 100, aperture 60 extends through at least a portion of upper piece 31. In some exemplary embodiments, such as with exemplary spray bottle 100, aperture 60 extends through at least a portion of the lower piece 36. In some exemplary embodiments, such as with exemplary spray bottle 100, aperture 60 extends through at least a portion of the upper and lower pieces 31 and 36.

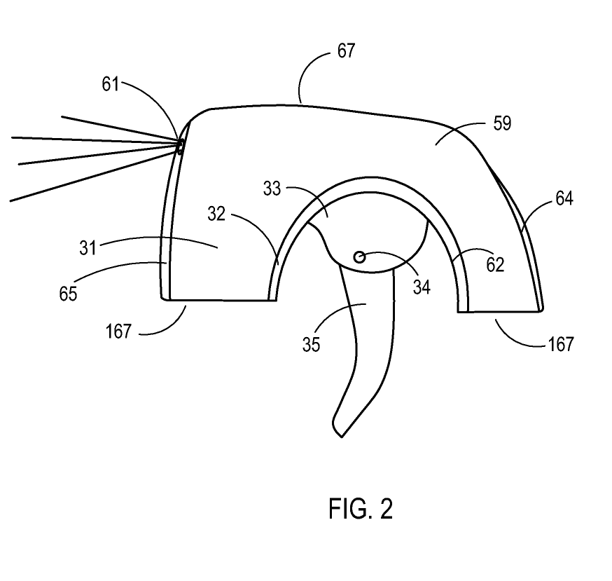

FIG. 2 provides a side elevation view of exemplary top piece 31 of exemplary spray bottle 100. As shown in FIG. 2, exemplary upper piece 31 comprises an upper portion of major side surface 59, upper end 67, opposite minor side surfaces 64 and 65, lower connecting portions 167, a fluid exit 61, spray trigger 35, trigger support structure 33 for spray trigger 35, metal or plastic pin 34, and a portion of aperture 60 having an upper piece aperture edge 62, which forms part of aperture edge 32 (shown in FIG. 1).

FIG. 3 depicts a front view of exemplary lower piece 36 of exemplary spray bottle 100 shown in FIG. 1. As shown in FIG. 3, exemplary lower piece 36 comprises lower portions of major side surfaces 58 and 59, a lower portion of minor side surface 65, bottom end 66, and forward upper surface 54. Proximate forward upper surface 54 is forward upper outer edge 55 and female connecting member 38. As discussed further below, female connecting member 38 may be used to connect exemplary lower piece 36 to exemplary upper piece 31 (via corresponding male connecting members on exemplary upper piece 31) at locations 68 and 69 shown in FIG. 1.

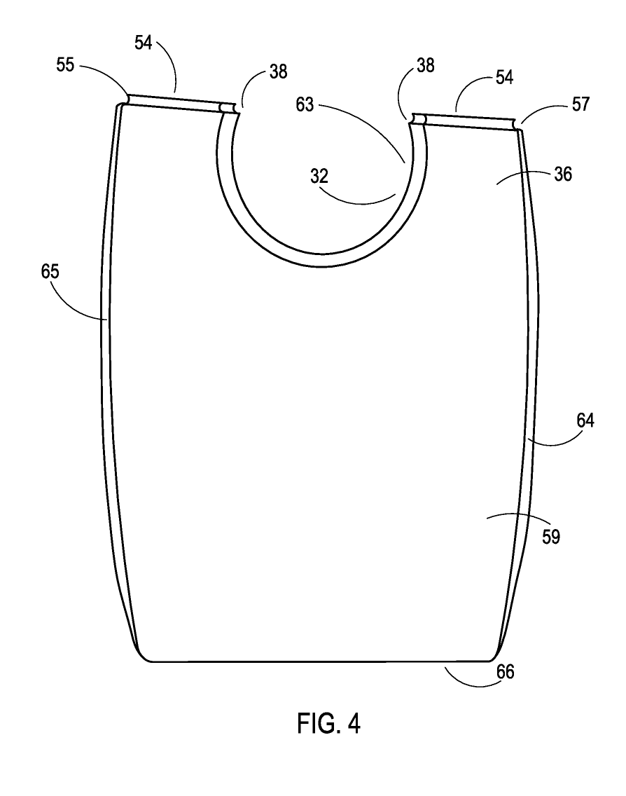

FIG. 4 depicts a side elevation view of exemplary lower piece 36. As shown in FIG. 4, exemplary lower piece 36 comprises a lower portion of major side surface 59, upper outer edges 55 and 57, forward upper surface portion 54 and rear upper surface portion 56 on opposite sides of aperture 60, female connecting members 38 on opposite sides of aperture 60, opposite minor side surfaces 64 and 65, bottom end 66, and a portion of aperture 60 having an lower piece aperture edge 63, which forms part of aperture edge 32 (shown in FIG. 1).

Desirably, spray bottles of the present invention comprise an upper piece, such as exemplary upper piece 31, wherein the upper piece comprises at least one male connecting member (or at least one female connecting member) proximate a lower surface thereof, and the lower piece, such as exemplary lower piece 36, comprises at least one corresponding female connecting member (or at least one corresponding male connecting member) proximate an upper surface thereof, the male connecting member (or the female connecting member) being operatively adapted to connect to the corresponding female connecting member (or the corresponding male connecting member) via the at least one male connecting member (or the at least one female connecting member) and the at least one female connecting member (or the at least one male connecting member).

As shown in exemplary spray bottle 100, in some exemplary embodiments, the upper piece, such as exemplary upper piece 31, comprises two male connecting members (or two female connecting members), and the lower piece, such as exemplary lower piece 36, comprises two corresponding female connecting members (or two corresponding male connecting members) proximate an upper surface thereof, the two male connecting members being operatively adapted to connect to the two corresponding female connecting members via the two male connecting members (or two female connecting members) and the two female connecting members (or two male connecting members).

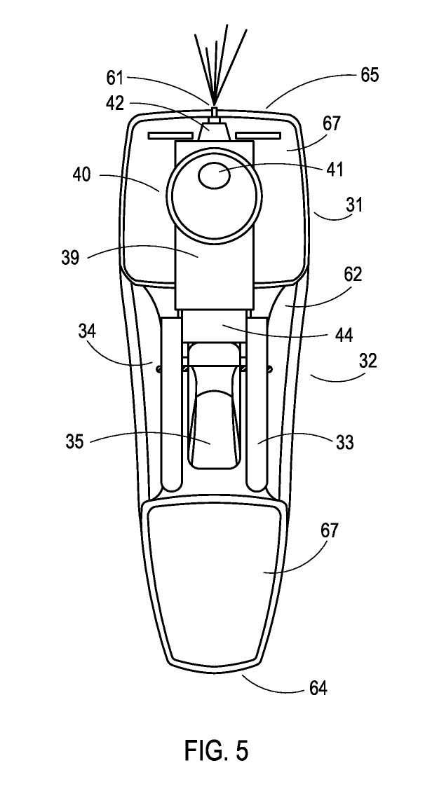

FIG. 5 depicts an underside view of exemplary top piece 31 shown in FIG. 2 with an exemplary spray pump mechanism and spray trigger 35 attached thereto. As shown in FIG.

5, exemplary top piece 31 comprises exemplary spray pump mechanism 39, which comprises (i) a spray fluid channel 88, (ii) a plunger 44 operatively adapted to extend into spray fluid channel 88 in response to a spray initiation force (e.g., pivotal force of upper plunger portion in response to pulling back spray trigger 35), (iii) a fluid expulsion apparatus 42 in fluid communication with spray fluid channel 88, and (iv) a hollow straw 41 in fluid communication with and extending below spray fluid channel 88.

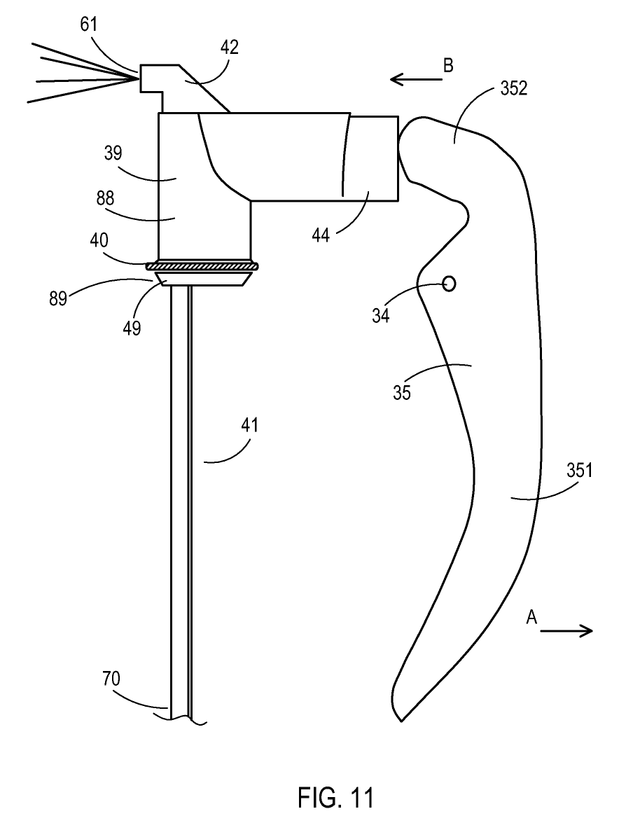

FIG. 5 also shows minor side surfaces 64 and 65, lower connecting portions 167, fluid exit 61, trigger support structure 33 for spray trigger 35, metal or plastic pin 34, upper piece aperture edge 62, which forms part of aperture edge 32 (shown in FIG. 1), and optional pump clips 43 attached to upper piece 31 to secure and stabilize exemplary spray pump mechanism 39 along a lower portion of upper piece 31. FIG. 5 also shows rubber gasket 40 of exemplary spray pump mechanism 39, which is operatively adapted, in some embodiments, to seal upper piece 31 from fluid contained in lower piece 36 (discussed further below in reference with FIG. 11).

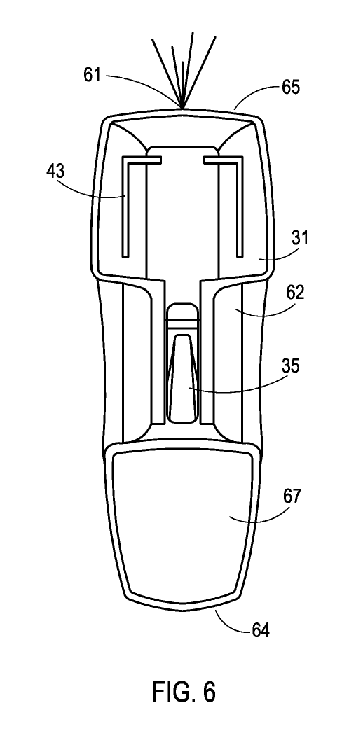

FIG. 6 depicts an underside view of exemplary upper piece 31 of FIG. 2 with only an exemplary spray trigger 35 attached (i.e., without exemplary spray pump mechanism 39). As shown in FIG. 6, exemplary top piece 31 comprises minor side surfaces 64 and 65, lower connecting portions 167, fluid exit 61, upper piece aperture edge 62, which forms part of aperture edge 32 (shown in FIG. 1), and optional pump clips 43 attached to upper piece 31 to secure and stabilize exemplary spray pump mechanism 39 (not shown) along a lower portion of upper piece 31.

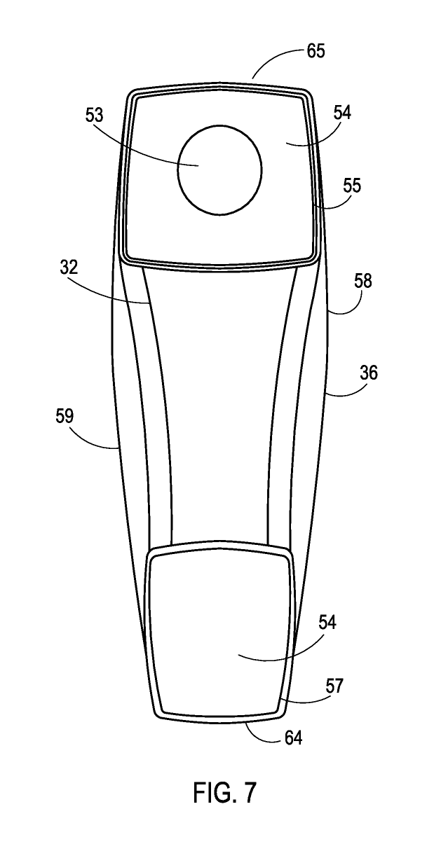

FIG. 7 depicts a view of exemplary lower piece 36 of FIG. 3 as viewed from above (and down on) exemplary lower piece 36. As shown in FIG. 7, exemplary lower piece 36 comprises lower portions of major side surfaces 58 and 59, a lower portion of minor side surfaces 64 and 65, upper surface portions 54 and 56, and upper outer edge portions 55 and 57 on opposite sides of aperture edge 32, and lower aperture edge portion 63.

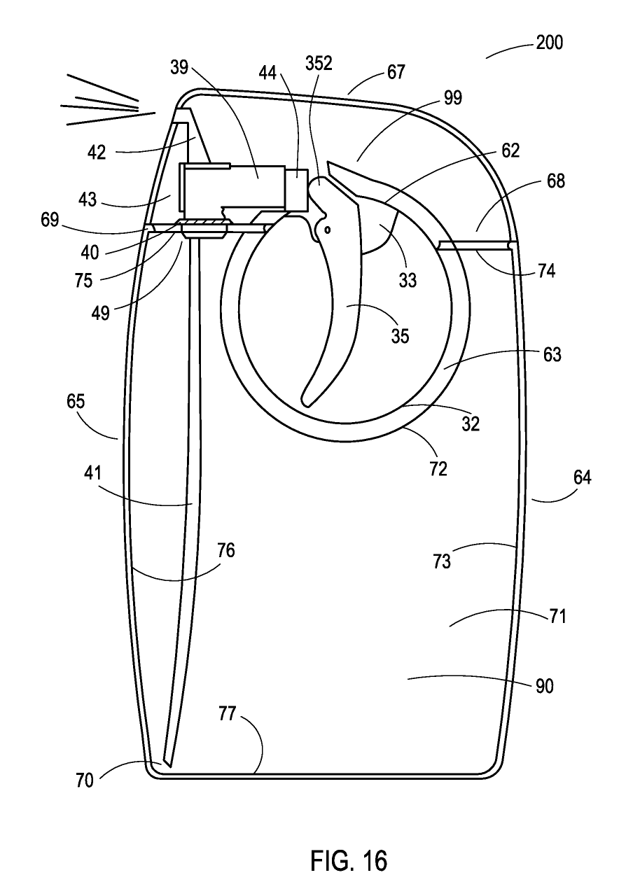

FIG. 7 depicts a desired embodiment wherein exemplary lower piece 36 comprises a fluid storage compartment bound by surfaces of exemplary lower piece 36 (discussed further below with reference to FIG. 16). The lower piece, such as exemplary lower piece 36, may comprise at least one lower piece opening 53 that provides access to the fluid storage compartment. As shown in FIG. 7, exemplary lower piece 36 comprises a single lower piece opening 53 that provides access to the fluid storage compartment, wherein single lower piece opening 53 is positioned within and through upper surface portion 54 positioned adjacent minor side surface 65 (i.e., towards a front of exemplary spray bottle 100). It should be noted that exemplary rear upper surface portion 56 does not have an opening therethrough.

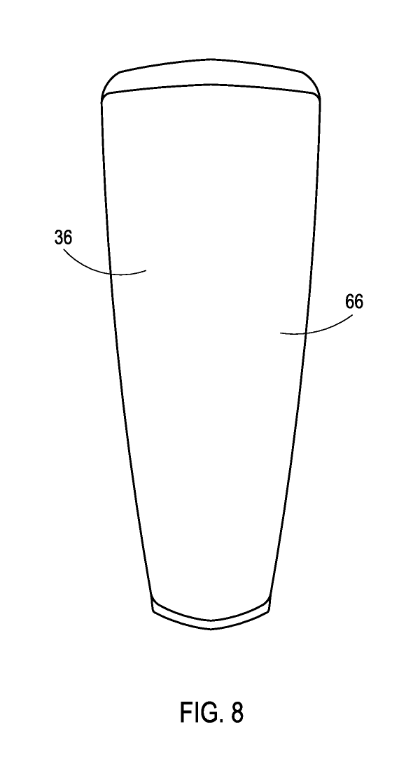

FIG. 8 depicts a view of exemplary lower piece 36 of FIG. 3 as viewed from below (and up at) exemplary lower piece 36. As shown in FIG. 8, exemplary lower piece 36 comprises bottom end 66, lower portions of major side surfaces 58 and 59, and lower portions of minor side surfaces 64 and 65.

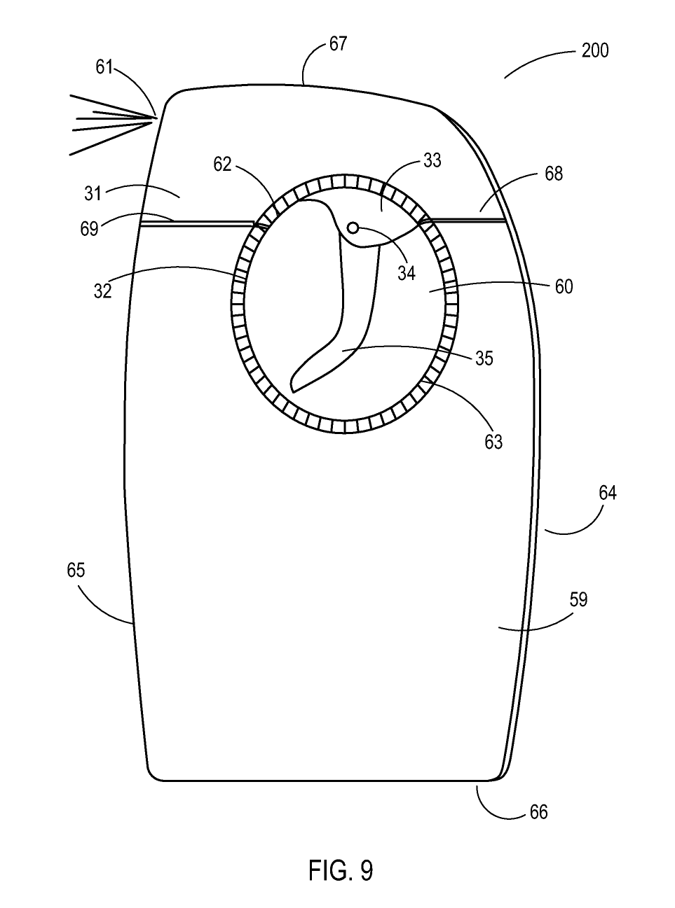

FIG. 9 depicts a side view of another exemplary spray bottle 200 of the present invention showing exemplary spray bottle aperture 60 therein with exemplary spray trigger 35 positioned within exemplary aperture 60. As shown in FIG. 9, exemplary spray bottle 200 comprises major side surface 59 (with another major side surface 58 along an opposite side of the container), upper end 67, lower end 66, support structure 33 for spray trigger 35, aperture edge 32, and metal or plastic pin 34 to attach spray trigger 35 to support structure 33 and provide a pivot point for spray trigger 35. Similar to exemplary spray bottle 100, exemplary spray bottle 200 comprises upper piece 31 and lower piece 36 (i) forming major side surfaces 58 and 59, and minor side surfaces 64 and 65, and (ii) being connectable to one another at locations 68 and 69 on opposite sides of aperture 60 having aperture edge 32, upper aperture edge 62 (along a portion of upper piece 31) and lower aperture edge 63 (along a portion of lower piece 36). In contrast to exemplary spray bottle 100, exemplary spray bottle 200 comprises a circular aperture 60 (instead of an oval shape).

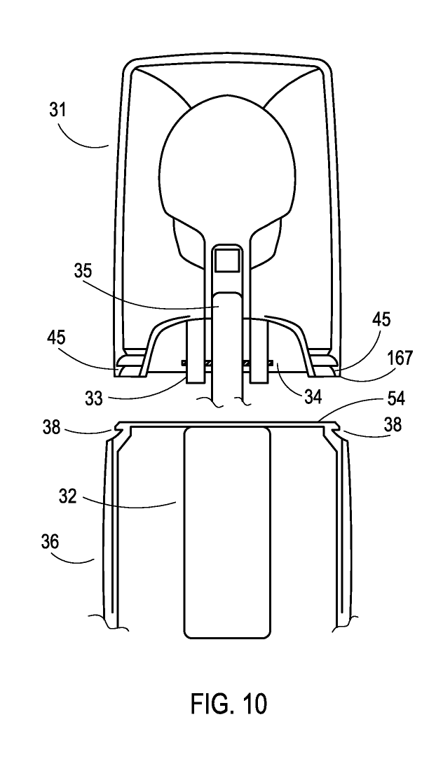

FIG. 10 depicts a cut-away view of (i) exemplary upper piece 31 with spray trigger 35 attached and (ii) exemplary lower section 36 of exemplary spray bottle 200 shown in FIG. 9. As shown in FIG. 10, exemplary upper piece 31 comprises male connecting members 45 positioned along opposite sides of lower connecting portion 167, while exemplary lower piece 36 comprises two corresponding female connecting members 38 positioned along opposite sides of forward upper surface portion 54.

FIG. 11 depicts a side view of exemplary spray pump mechanism 39, an exemplary hollow straw 41, and an exemplary spray trigger device 35 in combination with exemplary spray pump mechanism 39. FIG. 11 depicts one desired feature of the present invention, wherein exemplary spray bottle 200 comprises exemplary spray trigger 35 pivotally mounted within aperture 60, and movement of a lower portion 351 of spray trigger 35 in a first direction (shown by arrow A in FIG. 11) causes an upper portion 352 of spray trigger 35 to move in a second direction (shown by arrow B in FIG. 11), the second direction being an opposite direction to the first direction.

FIG. 11 depicts another desired feature of the present invention, wherein exemplary spray bottle 200 comprises exemplary plunger 44, which moves toward (i) fluid expulsion apparatus 42 and (ii) fluid exit 61 of the container (not shown) in response to a spray initiation force exerted on plunger 44 by upper portion 352 of spray trigger 35.

Although not shown in FIG. 11, exemplary spray fluid channel 88 typically comprises a spring positioned within exemplary spray fluid channel 88 so as to provide resistance to plunger 44 moving in direction B. As plunger 44 moves in direction B, a spring (not shown) is compacted into a high tension state. As pressure is released from lower portion 351 of spray trigger 35, the spring forces plunger 44 back to its original position (i.e., moves plunger 44 in direction A). Although exemplary spray fluid channel 88 has been described as being useable with a spring, it should be understood that any component that contracts or compacts by movement of plunger 44 in direction B, and causes plunger 44 to move back to its original position (i.e., move in direction A) as pressure is released from lower portion 351 of spray trigger 35 may be used in exemplary spray fluid channel 88.

As shown in FIG. 11, exemplary spray fluid channel 88 comprises a male fitting 49 positioned proximate a lower portion 89 of spray fluid reservoir 88 with male fitting 49 being operatively adapted to connect to (i) a corresponding female fitting (not shown) on a lower piece (e.g., exemplary lower piece 36) of the container or (ii) an opening that provides access to a fluid storage compartment within the lower piece of the container (e.g., similar to exemplary opening 53 shown in FIG. 7). Desirably, exemplary spray pump mechanism 39 further comprises a gasket 40 extending around lower portion 89 of spray fluid reservoir 88 above male fitting 49, wherein gasket 40 is operatively adapted to help seal a junction between spray fluid reservoir 88 and (i) a corresponding female fitting (not shown) on a lower piece (e.g., exemplary lower piece 36) of the container or (ii) an opening that provides access to a fluid storage compartment within the lower piece of the container (e.g., similar to exemplary opening 53 shown in FIG. 7).

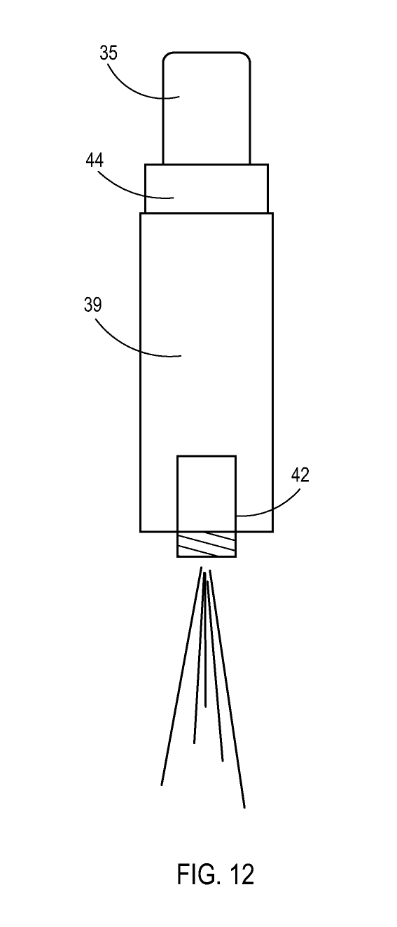

FIG. 12 depicts a view of exemplary spray pump mechanism 39 and exemplary spray trigger device 35 of FIG. 11 as viewed from above exemplary spray pump mechanism 39. As shown in FIG. 12, upper portion 352 of exemplary spray trigger 35 is in contact with spray fluid reservoir 88. In other embodiments (not shown), additional hardware may be used to attach upper portion 352 of exemplary spray trigger 35 is in contact with spray fluid reservoir 88.

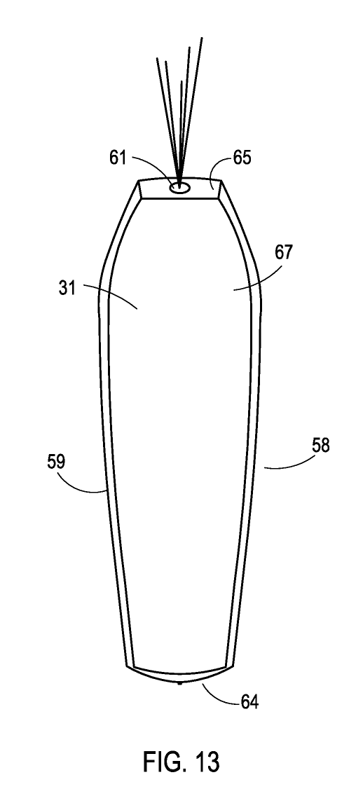

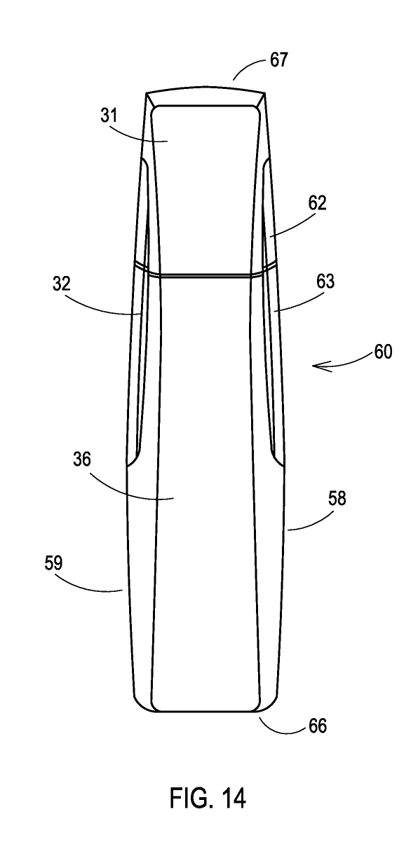

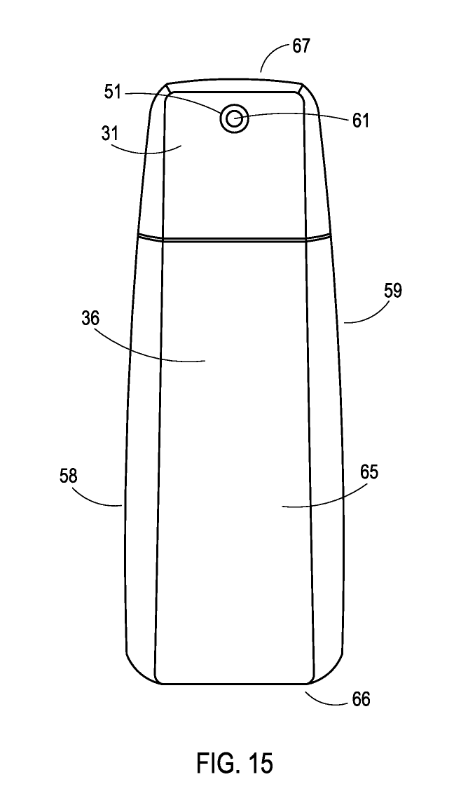

FIG. 13 depicts a view of exemplary spray bottle 200 of FIG. 9 as viewed from above exemplary spray bottle 200. FIG. 14 depicts an elevation view of a back side of exemplary spray bottle 200 of FIG. 9. FIG. 15 depicts an elevation view of a front side of exemplary spray bottle 200 of FIG. 9.

FIG. 16 depicts a cut-away view of exemplary upper piece 31 and exemplary lower section 36 of exemplary spray bottle 200 of FIG. 9 showing exemplary spray pump mechanism 39, exemplary hollow straw 41 and exemplary spray trigger device 35 attached to sprat trigger support 33 via exemplary metal or plastic pin 34. As shown in FIG. 16, exemplary spray bottle 200 comprises upper piece 31 and lower piece 36. Upper piece 31 and lower piece 36 are operatively adapted to connect to one another to form the container (e.g., exemplary spray bottle 200) and the at least one major side surface (e.g., exemplary side surfaces 58 and 59 shown in FIG. 15). Further, hollow straw 41 is attached to upper piece 31 and extends into a fluid storage compartment 90 within lower piece 36 of the container when upper piece 31 is connected to lower piece 36. In this exemplary embodiment, fluid storage compartment 90 comprises a volume bound by the following inner container surfaces: inner side surfaces 73 and 76, inner bottom surface 77, inner aperture surface 72, and inner upper surface portions 74 and 75 positioned on opposite sides or aperture 60. As shown in FIG. 16, the container volume is present on opposite sides of spray trigger 35 and aperture 60, and is present solely within lower piece 36.

As shown in FIG. 16 and in desired exemplary embodiments of the present invention, (i) hollow straw 41 and (ii) fluid exit 61 of exemplary spray bottle 200 are both positioned in front of exemplary spray trigger 35. Further, as shown in FIG. 16 and in desired exemplary embodiments of the present invention, tip 70 of hollow straw 41 is positioned proximate a lower corner of fluid storage compartment 90 with the lower corner being at a junction of inner side surface 76 and inner bottom surface 77.

It should be noted that the ability of tip 70 of hollow straw 41 to be positioned at the junction of inner side surface 76 and inner bottom surface 77 enables a user of exemplary spray bottle 200 to utilize essentially all of the fluid within exemplary spray bottle 200 during use. In other words, the position of tip 70 effectively drains spray bottle 200 during use. It should be further noted that tip 70 of hollow straw 41 is positionable at the junction of inner side surface 76 and inner bottom surface 77 by simply attaching exemplary spray pump mechanism 39 to lower piece 36. In some embodiments, hollow straw 41 extends directly downward from opening 53 in lower piece 36 so as to be positionable at the junction of inner side surface 76 and inner bottom surface 77. In other embodiments, hollow straw 41 may comprise some curvature along hollow straw 41 so that tip 70 is positioned at the junction of inner side surface 76 and inner bottom surface 77 when connected to lower piece 36.

FIG. 16 also shows a spray trigger stop 99 positioned proximate upper portion 352 of exemplary spray trigger 35. Spray trigger stop 99 prevents upper portion 352 of exemplary spray trigger 35 from moving too far to the right (i.e., in direction A). Although exemplary spray bottle 200 is shown with spray trigger stop 99, it should be noted that any component may be used in place of positioned spray trigger stop 99 as long as the component prevents upper portion 352 of exemplary spray trigger 35 from moving too far to the right.

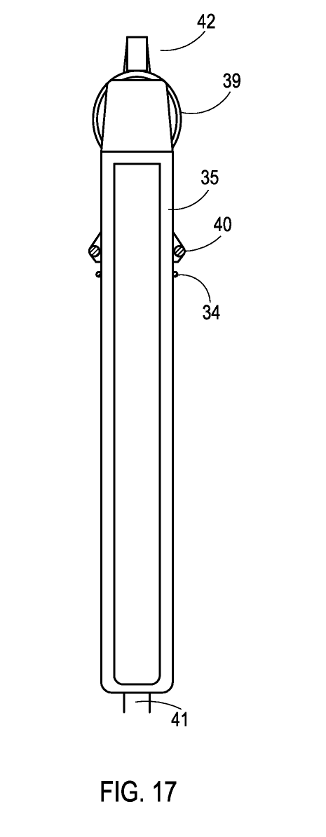

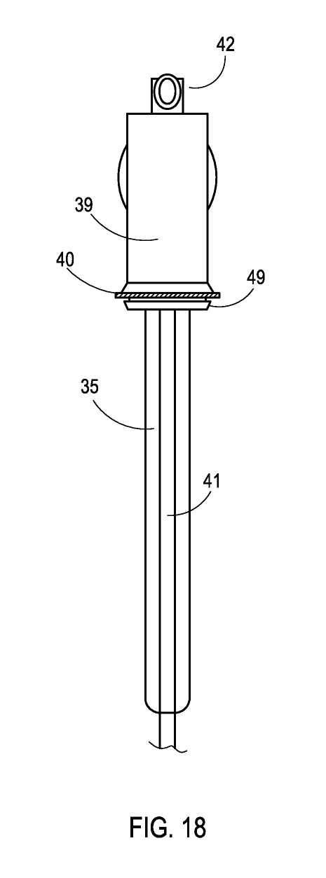

FIG. 17 depicts a rear view of (i) exemplary spray trigger 35 in combination with (ii) exemplary spray pump mechanism 39 shown in FIG. 16. FIG. 18 shows a frontal view of (i) exemplary spray pump mechanism 39, (ii) exemplary hollow straw 41, and (iii) exemplary trigger device 35 shown in FIG. 16.

As shown in exemplary spray bottles 100 and 200, spray bottles of the present invention may have a variety of bottle and aperture shapes. Suitable aperture shapes include, but are not limited to, apertures having a cross-sectional shape selected from the group of shapes consisting of a circle, a tear-drop, a square, a diamond, a triangle, a rhombus, a star, a hexagon, a rectangle, or a parallelogram, or any other multi-sided shape. In one desired embodiment, the aperture has a cross-sectional shape comprising a circle.

The present invention is further directed to methods of making the spray bottle, wherein the spray bottle comprises one or more of the features described above. Methods of making the spray bottles of the present invention may include, but are not limited to, one or more of the following method steps: thermoforming (e.g., injection molding, blow molding, etc.) one or more outer bottle pieces (e.g., lower and upper pieces 31 and 36, spray trigger 35, etc.); thermoforming (e.g., molding, blow molding, etc.) one or more inner bottle pieces (e.g., plunger 44, spray fluid channel 88, hollow straw 41, etc.); assembling inner pieces with one another to form a spray pump mechanism (e.g., exemplary spray pump mechanism 39); assembling one or more outer pieces with one another to form a spray bottle having an aperture therethrough and a spray trigger positioned within the aperture (e.g., exemplary spray trigger 35 within aperture 60); and filling a fluid storage compartment (e.g., fluid storage compartment 90) with a sprayable fluid.

The present invention is even further directed to methods of using any of the above-described spray bottles. Methods of using any of the spray bottles of the present invention may include, but are not limited to, one or more of the following steps: filling a fluid storage compartment (e.g., fluid storage compartment 90) with a sprayable fluid; inserting one or more fingers through an aperture within the spray bottle (e.g., exemplary spray trigger 35); pointing a fluid exit (e.g., exemplary fluid exit 51) of the spray bottle at a spray location; applying pressure onto a spray trigger so as to initiate fluid flow through the spray bottle; and releasing pressure from a spray trigger to stop fluid flow from exiting the spray bottle.

Referring to FIG. 16, the step of applying pressure onto exemplary spray trigger 35 so as to initiate fluid flow through exemplary spray bottle 200 causes plunger 44 to enter into spray fluid channel 88 (and compresses a spring or other component (not shown) therein), reducing a fluid-containing volume within spray fluid channel 88, and forcing fluid within spray fluid channel 88 through fluid expulsion apparatus 42 and fluid exit 61. The step of releasing pressure from exemplary spray trigger 35 to stop fluid flow from exiting exemplary spray bottle 200 causes plunger 44 to move out of spray fluid channel 88 (due to a pushing force on a spring or similar component (not shown) onto plunger 44), causing fluid within fluid storage compartment 90 to enter hollow straw 41 through tip 70, travel upward through hollow straw 41, and enter into spray fluid channel 88 to occupy space previously occupied by plunger 44.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A spray bottle comprising:
a container comprising an upper end, a lower end, and at least one major side surface between the upper end and the lower end;
a spray mechanism operatively adapted to spray a fluid from the container;
a spray trigger operatively adapted to initiate fluid flow of a fluid from the container through the spray mechanism; and
an aperture extending through the at least one major side surface of the container from a first side of the container to a second side of the container, said aperture being completely surrounded by portions of the at least one major side surface;
wherein said spray trigger is positioned within said aperture and pivotally mounted within said aperture, and movement of a lower portion of said spray trigger in a first direction causes an upper portion of said spray trigger to move in a second direction, the second direction being an opposite direction to the first direction.

2. The spray bottle of claim 1, wherein the container comprises two major side surfaces with a first major side surface along the first side of the container, and a second major side surface along the second side of the container.

3. The spray bottle of claim 2, wherein the container comprises an upper piece and a lower piece, said upper and lower pieces being operatively adapted to connect to one another to form said container and the at least one major side surface.

4-5. (canceled)

6. The spray bottle of claim 3, wherein said aperture extends through at least a portion of the upper and lower pieces.

7. The spray bottle of claim 6, wherein the lower piece comprises a fluid storage compartment.

8. The spray bottle of claim 7, wherein the lower piece comprises at least one lower piece opening that provides access to the fluid storage compartment.

9. The spray bottle of claim 8, wherein the lower piece comprises a single lower piece opening that provides access to the fluid storage compartment.

10. The spray bottle of claim 9, wherein the upper piece comprises at least one male connecting member proximate a lower surface thereof, and the lower piece comprises at least one corresponding female connecting member proximate an upper surface thereof, said male connecting member being operatively adapted to connect to said corresponding female connecting member via said at least one male connecting member and said at least one female connecting member.

11. The spray bottle of claim 10, wherein the upper piece comprises two male connecting members, and the lower piece comprises two corresponding female connecting members proximate an upper surface thereof, said male connecting member being operatively adapted to connect to said corresponding female connecting member via said two male connecting member and said two female connecting member.

12. A spray bottle of comprising:
a container comprising an upper end, a lower end, and at least one major side surface between the upper end and the lower end;
a spray mechanism operatively adapted to spray a fluid from the container;
a spray trigger operatively adapted to initiate fluid flow of a fluid from the container through the spray mechanism; and
an aperture extending through the at least one major side surface of the container from a first side of the container to a second side of the container, said aperture being completely surrounded by portions of the at least one major side surface;
wherein said spray trigger is positioned within said aperture and is attached to an upper region of the aperture.

13. The spray bottle of claim 12, wherein the container further comprises a trigger support member positioned within the aperture, said spray trigger being attached to said trigger support member.

14. The spray bottle of claim 13, wherein the container further comprises a pin, said pin extending through said spray trigger so as to attach said spray trigger to said trigger support member.

15. The spray bottle of claim 14, wherein said spray mechanism comprises (i) a spray fluid channel, (ii) a plunger operatively adapted to extend into said spray fluid channel in response to a spray initiation force, (iii) a fluid expulsion apparatus in fluid communication with said spray fluid channel, and (iv) a hollow straw in fluid communication with and extending below said spray fluid channel.

16. The spray bottle of claim 15, wherein said spray trigger is pivotally mounted within said aperture, and movement of a lower portion of said spray trigger in a first direction causes an upper portion of said spray trigger to move in a second direction, the second direction being an opposite direction to the first direction.

17. A spray bottle comprising:
a container comprising an upper end, a lower end, and two major side surfaces between the upper end and the lower end;
a spray mechanism operatively adapted to spray a fluid from the container, said spray mechanism comprising (i) a spray fluid channel, (ii) a plunger operatively adapted to extend into said spray fluid channel in response to a spray initiation force, (iii) a fluid expulsion apparatus in fluid communication with said spray fluid channel, and (iv) a hollow straw in fluid communication with and extending below said spray fluid channel;
a spray trigger operatively adapted to initiate fluid flow of a fluid from the container through the spray mechanism; and
an aperture extending through the two major side surfaces of the container from a first side of the container to a second side of the container, said aperture being completely surrounded by portions of both of the two major side surfaces;
wherein said spray trigger is positioned within said aperture and said plunger moves toward (i) said fluid expulsion apparatus and (ii) a fluid exit of the container in response to a spray initiation force exerted on said plunger by an upper region of said spray trigger.

18. The spray bottle of claim 17, wherein said spray fluid channel comprises a male fitting positioned proximate a lower portion of said spray fluid channel, said male fitting being operatively adapted to connect to (i) a corresponding female fitting on a lower piece of said container or (ii) an opening that provides access to a fluid storage compartment within the lower piece of said container.

19. The spray bottle of claim 18, wherein said spray mechanism further comprises a gasket extending around a lower portion of said spray fluid reservoir above said male fitting, said gasket being operatively adapted to help seal a junction between said spray fluid reservoir and said corresponding female fitting or said opening.

20. The spray bottle of claim 17, wherein the container comprises an upper piece and a lower piece, said upper and lower pieces being operatively adapted to connect to one another to form said container and the at least one major side surface, and said hollow straw is attached to said upper piece and extends into a fluid storage compartment within the lower piece of the container when the upper piece is connected to the lower piece.

21-22. (canceled)

23. The spray bottle of claim 1, wherein said aperture has a cross-sectional shape selected from the group of shapes consisting of a circle, a tear-drop, a square, a diamond, a triangle, a rhombus, a star, a hexagon, a rectangle, or a parallelogram, or any other multi-sided shape.

24. The spray bottle of claim 23, wherein said aperture has a cross-sectional shape comprising a circle.

25-29. (canceled)
